(19) United States
(12) Patent Application Publication
(10) Pub. No.: US 2019/0184528 A1
(43) Pub. Date: Jun. 20, 2019

(54) ATTACHMENT DEVICE

(71) Applicant: Robert Bosch GmbH, Stuttgart (DE)

(72) Inventors: Tobias HERR, Stuttgart (DE); Dietmar SAUR, Moessingen (DE); Jens BLUM, Filderstadt (DE)

(73) Assignee: Robert Bosch GmbH, Stuttgart (DE)

(21) Appl. No.: 16/323,161

(22) PCT Filed: Jul. 17, 2017
(86) PCT No.: PCT/EP2017/068046

§ 371 Date: Feb. 4, 2019

(30) Foreign Application Priority Data
Aug. 5, 2016 (DE) 102016214616.5

(51) Int. Cl. B25B 21/02; B25F 5/00

(52) U.S. Cl. CPC B25B 21/02; B25F 3/00; B25F 5/001

(57) ABSTRACT

An attachment device for mounting to a handheld power tool, including a tool fixture for receiving an insertable tool, and including at least one rotary impact mechanism, which, in at least one operating state, is configured to generate a rotary impact pulse for an impact drive of the tool fixture. The rotary impact mechanism includes at least one planetary gear set, which is configured to convert a rotational speed and/or a torque of an output shaft of the handheld power tool to a rotational speed and/or a torque of the tool fixture.

### FIELD OF THE INVENTION

The present invention relates to an attachment device for mounting to a handheld power tool and a related handheld power tool system.

### BACKGROUND INFORMATION

Patent document DE 10 2005 048 345 A1 discusses an attachment device for mounting to a handheld power tool, including a tool fixture for receiving an insertable tool, and including at least one rotary impact mechanism, which, in at least one operating state, is configured to generate a rotary impact pulse for an impact drive of the tool fixture.

### SUMMARY OF THE INVENTION

The present invention is directed to an attachment device for mounting to a handheld power tool, including a tool fixture for receiving an insertable tool, and including at least one rotary impact mechanism, which, in at least one operating state, is configured to generate a rotary impact pulse for an impact drive of the tool fixture.

It is provided that the rotary impact mechanism include at least one planetary gear set, which is configured to convert a rotational speed and/or a torque of an output shaft of the handheld power tool to a rotational speed and/or a torque of the tool fixture.

In this connection, an “attachment device” should be understood as, in particular, a device, which is configured for operation by a base device, which includes a drive unit for a rotary drive. The attachment device may be provided for a specific intended use. The attachment device may be intended exclusively for operation by a base device, in particular, by a handheld power tool. The attachment device may be replaceable with other attachment devices having the same intended use or having a different intended use. It particularly may be provided for the base device to be operable independently of the attachment device. A “handheld power tool” should be understood as, in particular, a machine tool, which may be held in the hand for use by an operator, but is advantageously a cordless screwdriver, a drill, a hammer drill and/or percussion hammer, a milling tool, a grinder, and/or a multifunctional tool. The handheld power tool may include a drive unit for a rotary drive, which may be, an electric drive unit, for example, an electric motor. The handheld power tool may be operable independently of an electrical network. The handheld power tool may be connectible to an energy storage device, for example, a battery pack. A “tool fixture” should be understood as, in particular, a component part, which is configured to hold a machining tool in a mounting region and to enter into a form-locked and/or force-locked connection with the machining tool in the circumferential direction.

In this connection, a “rotary impact mechanism” is to be understood as, in particular, a striking mechanism, which is configured to convert an at least substantially continuous power output of a drive unit to a rotational pulse in the form of a stroke. The rotary impact mechanism may take the form of, in particular, a cam-type rotary impact mechanism or a V-groove rotary impact mechanism. In this connection, a “rotational impact pulse” is to be understood as, in particular, a periodically repeatable striking pulse. The striking pulse may take the form of a radial pulse and includes a radially directed component, whose magnitude is at least 80 percent, which may be 90 percent, and particularly may be 95 percent of a total magnitude of the striking pulse. In this connection, directional information, such as “axial,” “radial,” and “in the circumferential direction,” should be understood to be, in particular, in relation to an axis of rotation. In this context, “provided” is to be understood as, in particular, specially configured and/or equipped. That an object is provided for a particular function, is to be understood to mean that, in particular, the object fulfills and/or executes this particular function in at least one application state and/or operating state. A “planetary gear set” is to be understood as, in particular, a gear unit, which includes at least one planet, which is connected to a planet carrier and is coupled to a ring gear in an outward radial direction and/or coupled to a sun gear in an inward radial direction. The sun gear, the planet and/or the ring gear may be made up of, in particular, circular gear wheels or of non-circular gear wheels matched to each other. A plurality of planetary gear sets may be connected in series, and/or a plurality of stages may be interposed between the planet gear and ring gear. A “ring gear” should be understood as, in particular, a gear wheel, which has a rim that is formed in the shape of a cylinder sleeve or in the shape of a discontinuous cylinder sleeve. As an alternative to the use of a planetary gear set, it is also conceivable to use a different type of gear construction appearing suitable to one skilled in the art, for example, a spur gear unit, and/or to use a combination of different types of gear construction.

Using such a refinement, an attachment device of the species may be provided, which has advantageous configuration features. In particular, by using a planetary gear set, an advantageously compact, inexpensive, efficient and/or robust supplementary device may be provided for implementing a rotary impact drive on a handheld power tool. In this manner, a range of application of a handheld power tool may be expanded in an advantageous manner. An attachment device may be provided, which is usable with different base devices, in particular, different handheld power tools. An attachment device for a large number of different insertable tools may be provided.

The rotary impact mechanism advantageously includes at least one drive element, which has an interconnection region that is connectible to an insertable tool fixture of the handheld power tool so as to be able to transmit power. An “insertable tool fixture” is to be understood as a fixture for at least an insertable tool, for example, for an insertable bit. The insertable tool fixture is advantageously formed as part of a machine interface, which is configured to couple the attachment devices simultaneously to a housing unit and to an output shaft. In this connection, a “drive element” should be understood as, in particular, an element, which is configured to transmit and/or relay a driving motion, which may be, an angular motion and/or rotational pulse. The drive element may be configured to transmit an angular motion in an axial direction and takes the form of, for example, a shaft. The drive element may be capable of being attached onto the insertable tool fixture. In this manner, an angular motion may be transmitted advantageously from the handheld power tool to the attachment device.

In addition, it is provided that at least part of the drive element be formed in one piece with a planet carrier of the planetary gear set. In particular, at least part of the drive element is formed as a spindle, which is connectible to an insertable tool fixture of the handheld power tool in an axially movable and rotatably fixed manner. “Formed in one piece” is to be understood as, in particular, at least integrally joined, for example, by a welding method, an adhesive bonding method, an injection molding method, and/or another method appearing to be suitable to one skilled in the art; and/or understood as formed advantageously in one piece, such as by production from casting and/or by production in a single-component or multicomponent injection molding method, and advantageously from a single blank. In a coupled state, the drive element advantageously mates with an opening of the insertable tool fixture. It is also conceivable for the drive element to have a holding fixture, with which, in a coupled state, an element of the insertable tool fixture engages. In this manner, the rotary impact mechanism may be joined to the handheld power tool particularly simply, rapidly and reliably, so as to be able to transmit power. A rotary impact mechanism constructed particularly simply may be provided. A particularly compact, rotary impact mechanism may be provided.

In addition, it is provided that the planetary gear set include at least two switchable gear speeds. The planetary gear set may have a gear ratio less than 1. In particular, the planetary gear set has a gear ratio between 0.1 and 0.8. Due to this, a rotational speed of the attachment device may be adapted advantageously to a rotary impact drive. A particularly efficient attachment device may be provided.

In addition, it is provided that the rotary impact mechanism have a switch element for switching off striking action and/or switching on striking action. The switch element may be configured for manipulation by the operator. In particular, the switch element includes an actuating element, which is situated between the drill chuck and the coupling unit in the axial direction. “Switching off striking action” should be understood as a unit, which is provided for switching off, interrupting and/or decoupling an impact drive. The attachment device may include a rotary drive, which is usable independently of the switching-off of striking action. Alternatively, it is conceivable for the rotary impact mechanism to have no device for switching off striking action. In such a variant, the attachment device is configured for constant rotary impact operation. The switch element may be configured to bring snap-in locking elements and/or detent regions of the rotary impact mechanism out of engagement and/or to fix them in an alternately disengaged position. In this manner, an attachment device usable in a particularly flexible manner may be provided.

In addition, it is provided that the attachment device have a coupling unit, which is provided for coupling to a housing of the handheld power tool in a detachable, rotatably fixed manner. This may allow an advantageously reliable connection between the attachment device and a handheld power tool to be achieved.

In addition, the attachment device may include a positioning unit, which is provided for fixing a handle in position. The positioning unit may be compatible with a handle positioning unit of a handheld power tool, which means that a handle belonging to a handheld power tool may be used advantageously. This may allow a handle to be mounted to the attachment device in an advantageously simple manner.

Furthermore, a handheld power tool system is provided, including an attachment device of the present invention, and including at least one handheld power tool for driving the attachment device. The handheld power tool may take the form of a battery-operated, handheld power tool. This allows a handheld power tool system to be provided for a large range of application. A large number of operating cases and/or applications may be achieved. A particularly cost-effective, handheld power tool system for rotary impact operation may be provided. This may eliminate the need to use a specially configured impact screwdriver. A particularly lightweight and/or particularly compact, handheld power tool, in particular, a cordless screwdriver, may be provided for coupling to the attachment device. A particularly efficient, handheld power tool system may be provided.

Further advantages are derived from the description of the figures that follows. Two exemplary embodiments of the present invention are shown in the figures. The drawing, the description, and the claims include numerous features in combination. One skilled in the art will necessarily consider the features individually, as well, and unite them to form useful, further combinations.

### BRIEF DESCRIPTION OF THE DRAWINGS

FIG. 1 shows a side view of a system including an attachment device of the present invention, and including a handheld power tool.

FIG. 2 shows a perspective view of a drive and operating region of the handheld power tool.

FIG. 3 shows a perspective view of a detail of a machine interface of the handheld machine tool.

FIG. 4 shows a sectional view of the attachment device along a drive and operating axis.

FIG. 5 shows a schematic representation of a further exemplary embodiment, including a gear unit.

### DETAILED DESCRIPTION

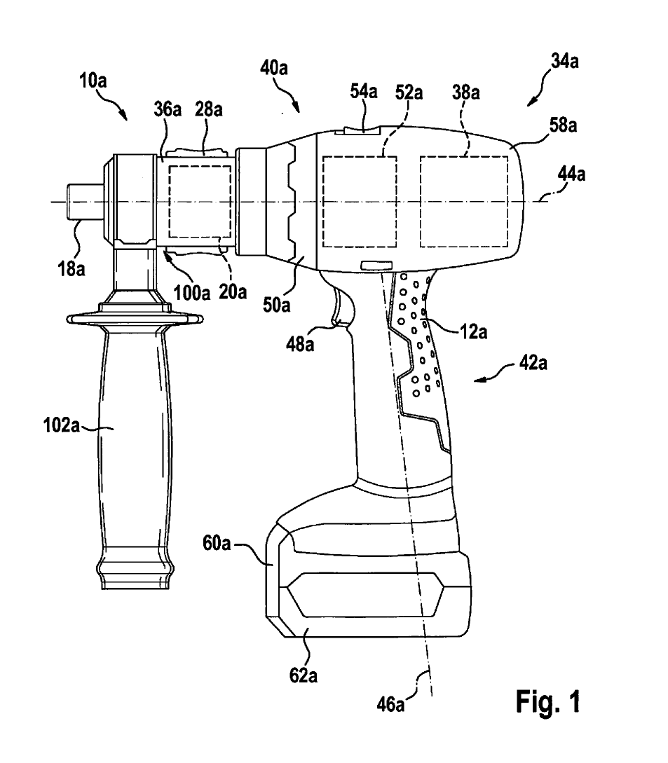

FIG. 1 shows a handheld power tool system 34a including a handheld power tool 12a and including an attachment device 10a, which has a rotary impact mechanism 20a. Attachment device 10a is configured for mounting to handheld power tool 12a and includes a coupling unit 14a, which is provided for coupling attachment device 10a to handheld power tool 12a. Coupling unit 14a is configured for coupling to an insertable tool fixture 16a of handheld power tool 12a. Coupling unit 14a is provided for coupling to a tool housing unit 58a of handheld power tool 12a in a detachable, rotatably fixed manner. Attachment device 10a includes a tool fixture 18a for holding an insertable tool. It is conceivable for handheld power tool system 34a to include further attachment devices, which are configured for coupling to handheld power tool 12a. Attachment device 10a includes a positioning unit 100a, which is provided for fixing a handle 102a in position. In at least one operating state, rotary impact mechanism 20a is configured to generate a rotary impact pulse for an impact drive of tool fixture 18a. Attachment device 10a includes a housing unit 36a, in which rotary impact mechanism 20a is situated. Rotary impact mechanism 20a includes a switch element 28a for switching off striking action and/or switching on striking action.

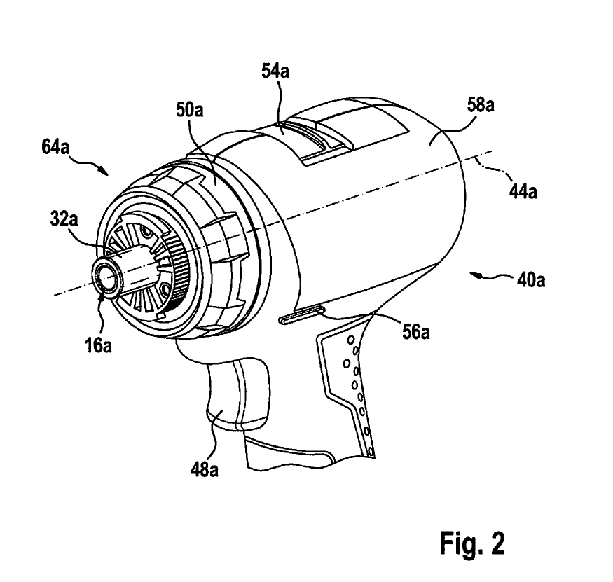

In the present exemplary embodiment, handheld power tool 12a takes the form of a cordless screwdriver. Handheld power tool 12a includes an electric drive unit 38a, which has an electric motor. Handheld power tool 12a includes an output shaft 32a, which is configured to transmit a torque and/or an angular motion generated by drive unit 38a (cf. FIG. 2). In the present exemplary embodiment, handheld power tool 12a is formed in the shape of a pistol. Handheld power tool 12a has a driving and operating region 40a and a handle region 42a. Handheld power tool 12a has a driving and operating axis 44a and a handle axis 46a. Driving and operating axis 44a and handle axis 46a form an angle of approximately 80 degrees with each other. It is conceivable for driving and operating axis 44a and handle axis 46a to form an angle, which has a value in a range of values between 60 degrees and 90 degrees, or another value appearing suitable to one skilled in the art. It is also conceivable for driving and operating axis 44a and handle axis 46a to be positioned in alignment with each other.

Handheld power tool 12a includes a switch element, which is configured to switch on and/or switch off drive unit 38a and/or to set a rotational speed of handheld power tool 12a and/or a torque of handheld power tool 12a. The switch element includes an actuating element 48a, which is configured to be manipulated by a user. Actuating element 48a takes the form of a pressure-operated switch. Handheld power tool 12a includes a torque limiter, which is configured to set a maximum torque transmitted by drive unit 38a to output shaft 32a. The torque limiter includes an adjusting collar 50a, which is configured for manipulation by the user. Handheld power tool 12a includes a gear unit 52a. Gear unit 52a is configured to convert a rotational speed and/or a torque of drive unit 38a to a rotational speed and/or a rotational speed of tool fixture 18a. Gear unit 52a has a plurality of gear speeds, which have a different gear ratio. Handheld power tool 12a includes a gear changer, which is configured to set a gear speed. The gear changer includes an actuating element 54a, which is configured to be actuated by the user. In the present exemplary embodiment, actuating element 54a takes the form of a sliding element. Handheld power tool 12a includes a rotational direction switch, which is provided for setting a direction of rotation of output shaft 32a. The rotational direction switch includes an actuating element 56a, which is configured for manipulation by the user. In the present exemplary embodiment, actuating element 56a takes the form of a sliding element.

Handheld power tool 12a includes a tool housing unit 58a, which encloses and supports drive unit 38a and gear unit 52a. Tool housing unit 58a extends over driving and operating region 40a and handle region 42a. Handheld power tool 12a is configured to be supplied power by a battery device 60a. Handheld power tool 12a includes a battery interface unit for battery device 60a. The battery interface unit for battery device 60a is situated at an end of the handle region 42a facing away from driving and operating region 40a. The battery interface unit is configured to connect a housing unit 62a of battery device 60a to tool housing unit 58a of handheld power tool 12a without a tool, in a detachably secure manner.

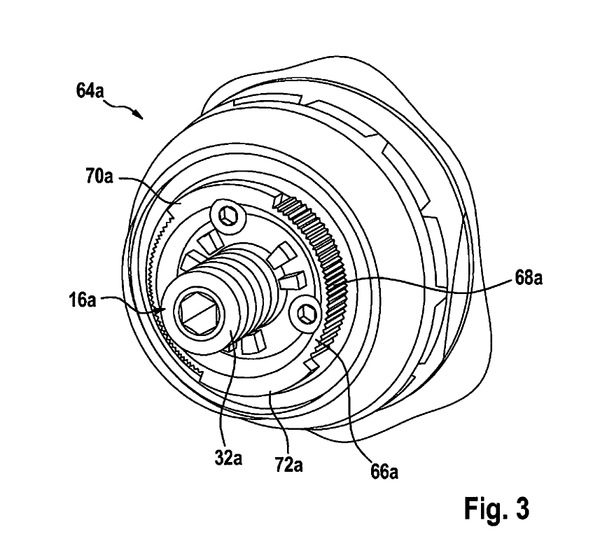

Handheld power tool 12a includes a machine interface 64a, which is configured for mounting attachment device 10a in what may be a rotation-locked manner (cf. FIG. 3). Machine interface 64a has a fastening element 66a situated at an end face of tool housing unit 58a. At least sections of fastening element 66a are sleeve-shaped and/or annular. At an outer circumference, fastening element 66a includes at least one blocking element 68a and at least two retaining elements 70a, 72a. Blocking element 68a may include at least one set of blocking gear teeth, and in the present exemplary embodiment, the at least two retaining elements 70a, 72a take the form of a type of bayonet to produce a bayonet joint. Machine interface 64a is provided for connecting the attachment device 10a mechanically. Coupling unit 14a of attachment device 10a is configured for detachable mechanical coupling to machine interface 64a.

Output shaft 32a emerges from handheld power tool 12a in the region of machine interface 64a. Output shaft 32a has an axis of rotation, which corresponds to driving and operating axis 44a of handheld power tool 12a. On a free end, output shaft 32a forms the insertable tool fixture 16a of handheld power tool 12a. Insertable tool fixture 16a is configured to hold an exchangeable, insertable tool, for example, a tool bit, which may be, having a screwdriver blade, or a hex headpiece. Insertable tool fixture 16a takes the form of a many-sided inner holding fixture and has a polygonal cross section. Insertable tool fixture 16a takes the form of a hexagonal inner fixture, for example, for receiving a hex drill bit or a screw bit.

Coupling unit 14a of attachment device 10a is configured to interact with machine interface 64a of handheld power tool 12a. Coupling unit 14a and machine interface 64a are configured to interconnect tool housing unit 58a of handheld power tool 12a and housing unit 62a of attachment device 10a in a detachable, secure manner, without a tool. Machine interface 64a and coupling unit 14a each have a form-locking region. The form-locking regions are provided for a form-locked connection with each other. Machine interface 64a and coupling unit 14a each have a force-locking region. The force-locking regions are provided for a frictional connection with each other. Coupling unit 14a and machine interface 64a are configured to lock onto each other. In the present exemplary embodiment, coupling unit 14a and machine interface 64a form a bayonet joint. Coupling unit 14a includes an actuating element 74a, which is configured to release a locked connection of coupling unit 14a with machine interface 64a of handheld power tool 12a. Tool fixture 18a is configured to receive an insertable tool.

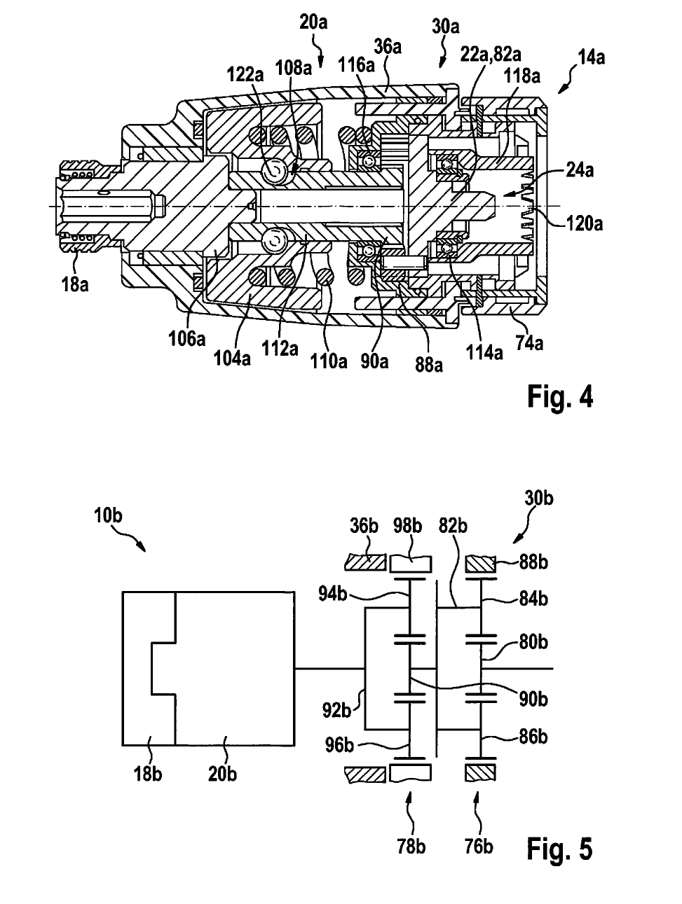

Rotary impact mechanism 20a includes a drive element 22a, which has an interconnection region 24a; in a state, in which the interconnection region is connected to handheld power tool 12a with the aid of coupling unit 14a, the interconnection region being connectible to the insertable tool fixture 16a of handheld power tool 12a so as to be able transmit power (cf. FIG. 4). Rotary impact mechanism 20a takes the form of a V-groove rotary impact mechanism. Rotary impact mechanism 20a is configured to convert a continuous power output of drive unit 38a of handheld power tool 12a to a rotational pulse in the form of a stroke. The energy release of drive unit 38a via a blow of a striker 104a of rotary impact mechanism 20a to a corresponding anvil 106a is transmitted to the insertable tool by a pulse of high power intensity. Anvil 106a is formed in one piece with tool fixture 18a. Striker 104a is supported in such a manner, that an axial movement and radial movement are possible. The axial movement is controlled, using V-shaped grooves 108a and driving balls 122a. A spring 110a provides for the restoring movement of striker 104a.

Rotary impact mechanism 20a includes a planetary gear set 30a, which is configured to convert a rotational speed and/or a torque of an output shaft 32a of handheld power tool 12a to a rotational speed and/or a torque of tool fixture 18a. Planetary gear set 30a is formed to have a single stage. Planetary gear set 30a has a gear ratio less than 1. Planetary gear set 30a includes a ring gear 88a, a planet carrier 82a and a sun gear 90a. Drive element 22a is configured to transmit a torque and/or an angular motion of output shaft 32a of handheld power tool 12a to planetary gear set 30a. Drive element 22a is formed in one piece with a planet carrier 82a of planetary gear set 30a. Rotary impact mechanism 20a includes an intermediate shaft 112a, which is at least substantially in alignment with output shaft 32a of handheld power tool 12a. Intermediate shaft 112a forms the sun gear 90a of planetary gear set 30a. In addition, rotary impact mechanism 20a includes a bearing 114a for supporting drive element 22a and a bearing 116a for supporting intermediate shaft 112a. Bearings 114a, 116a take the form of rolling-contact bearings, in particular, ball bearings.

Interconnection region 24a is situated at an end of drive element 22a facing away from tool fixture 18a. Interconnection region 24a is formed to correspond to insertable tool fixture 16a of handheld power tool 12a. Interconnection region 24a has a cross section, which is formed to correspond to the cross section of insertable tool fixture 16a of handheld power tool 12a. In the present exemplary embodiment, interconnection region 24a has an outer circumference in the form of a regular hexagon. In the state in which it is connected to handheld power tool 12a, interconnection region 24a engages with part of insertable tool fixture 16a. In the present exemplary embodiment, interconnection region 24a and insertable tool fixture 16a form a plug-and-socket connection. As an alternative, it is conceivable for interconnection region 24a to include a driving fixture, and, in a connected state, for output shaft 32a to engage with the driving fixture of interconnection region 24a. Housing unit 36a of attachment device 10a includes a housing element 118a, which is configured, in at least one operating state, to brace rotary impact mechanism 20a against insertable tool fixture 16a of handheld power tool 12a. In the present exemplary embodiment, housing element 118a forms engagement devices 120a of coupling unit 14a.

A further exemplary embodiment of the present invention is shown in FIG. 5. The following description and the figures are limited mainly to the differences between the exemplary embodiments; with regard to identically designated components, in particular, with regard to components having the same reference characters, reference also being able to be made, in principle, to the figures and/or the description of the other exemplary embodiments, in particular, of FIGS. 1 through 4. In order to distinguish between the exemplary embodiments, the letter “a” follows the reference numerals of the exemplary embodiment in FIGS. 1 through 4. In the exemplary embodiment of FIG. 5, the letter “a” is replaced by the letter “b.”

FIG. 5 shows a schematic representation of a further exemplary embodiment of an attachment device 10b, which includes a rotary impact mechanism 20b. Attachment device 10b is configured to be mounted on a handheld power tool 12b not shown in further detail and includes a coupling unit 14b, which is provided for coupling to the handheld power tool 12b. Coupling unit 14b is configured for coupling to an insertable tool fixture 16b of handheld power tool 12b. Attachment device 10b includes a tool fixture 18b for holding an insertable tool. In at least one operating state, rotary impact mechanism 20b is configured to generate a rotary impact pulse for an impact drive of tool fixture 18b. Attachment device 10b includes a housing unit 36b, in which rotary impact mechanism 20b is situated. Tool fixture 18b is configured to receive an insertable tool.

Attachment device 10b includes a two-stage planetary gear set 30b having a first gear stage 76b and an additional gear stage 78b. First gear stage 76b includes an input sun gear 80b, a planet carrier 82b, a plurality of planet elements 84b, 86b and a ring gear 88b mounted to the housing. Additional gear stage 78b includes a sun gear 90b connected to planet carrier 82b of first gear stage 76b in a rotatably fixed manner, a planet carrier 92b, a plurality of planet elements 94b, 96b and a switch-actuating ring gear 98b. Planetary gear set 30b has two switchable gear speeds. In a first of the gear speeds, switch-actuating ring gear 98b is mounted to the housing. In the present exemplary embodiment, switch-actuating ring gear 98b includes engagement devices not shown in further detail, which, in the first gear speed, are provided for a form-locked connection with housing unit 36b of attachment device 10b. In another of the gear speeds, switch-actuating ring gear 98b is connected to planet carrier 82b of first gear stage 76b in a rotatably fixed manner. At the same time, planet elements 94b, 96b of additional gear stage 78b are meshed with switch-actuating ring gear 98b. In the other gear speed, second gear stage 78b is short-circuited. In the other gear speed, planet carrier 92b of additional gear stage 78b has a rotational speed equal to that of sun gear 90b.

1-10. (canceled)

11. An attachment device for mounting to a handheld power tool, comprising:
a tool fixture for receiving an insertable tool; and
at least one rotary impact mechanism, which, in at least one operating state, is configured to generate a rotary impact pulse for an impact drive of the tool fixture;
wherein the rotary impact mechanism includes at least one planetary gear set, which is configured to convert a rotational speed and/or a torque of an output shaft of the handheld power tool to a rotational speed and/or a torque of the tool fixture.

12. The attachment device of claim 11, wherein the rotary impact mechanism includes at least one drive element, which has an interconnection region that is connectible to an insertable tool fixture of the handheld power tool so as to be able to transmit power.

13. The attachment device of claim 12, wherein at least part of the drive element is in one piece with a planet carrier of the planetary gear set.

14. The attachment device of claim 11, wherein the planetary gear set has at least two switchable gear speeds.

15. The attachment device of claim 11, wherein the planetary gear set has a gear ratio less than 1.

16. The attachment device of claim 11, wherein the rotary impact mechanism includes a switch element for switching off striking action and/or switching on striking action.

17. The attachment device of claim 11, further comprising:
a coupling unit, which is configured for detachable, rotatably fixed coupling to a tool housing unit of the handheld power tool.

18. The attachment device of claim 11, further comprising:
a positioning unit, which is configured to fix a handle in position.

19. A handheld power tool system, comprising:
an attachment device for mounting, including:
a tool fixture for receiving an insertable tool; and
at least one rotary impact mechanism, which, in at least one operating state, is configured to generate a rotary impact pulse for an impact drive of the tool fixture;
wherein the rotary impact mechanism includes at least one planetary gear set, which is configured to convert a rotational speed and/or a torque of an output shaft of the handheld power tool to a rotational speed and/or a torque of the tool fixture; and
at least one handheld power tool for driving the attachment device.

20. The handheld power tool system of claim 19, wherein the handheld power tool includes a battery-operated, handheld power tool.
